(19) United States
(12) Patent Application Publication
(10) Pub. No.: US 2015/0034794 A1
(43) Pub. Date: Feb. 5, 2015

(54) CONSTRUCT FOR ITEMS TO BE WALL MOUNTED AND METHODS OF MOUNTING

(71) Applicant: Marc R. Durante, Scotch Plains, NJ (US)

(72) Inventor: Marc R. Durante, Scotch Plains, NJ (US)

(21) Appl. No.: 13/953,802

(22) Filed: Jul. 30, 2013

(51) Int. Cl. F16M 13/02

(52) U.S. Cl. CPC F16M 13/02
USPC 248/544; 29/428

(57) ABSTRACT

An improvement in an item having a rear surface to be mounted facing a wall, the rear surface having a mounting structure including: (a) a rest surface that, in use, rests on a support structure affixed to the wall, and (b) a feed opening that serves as a guide for the placing of the rest surface on the support structure includes: a mounting dowel having a body extending from a mounting end to a marking end, the body being formed of a conformable material proximate the mounting end, wherein the mounting dowel is secured at the mounting structure by means of the conformable material being compromised by the contours of the mounting structure proximate the rest surface such that the conformable material is conformed to the contours proximate the rest surface and held thereby; and a marking substance at the marking end of the body.

### FIELD OF THE INVENTION

The present invention generally relates to items having rear surfaces to be mounted facing a wall. More particularly, the present invention relates to improvements in such items, particularly with respect to mounting structures at the rear surface thereof. The present invention also relates to methods for mounting items to a wall wherein the items have mounting structures at a rear surface thereof, the rear surface being mounted facing the wall.

### BACKGROUND OF THE INVENTION

Many items are mounted to a wall by having a mounting of the item supported on a support structure that is affixed to the wall. For example, speakers, sound bars, power strips, cordless phone docks, pictures and even television mounts are now commonly mounted in this manner. The mounting structure typically provides a rest surface that, in use, rests on the support structure that is affixed to the wall, and, in this manner, the item has its weight supported on the support structure.

By way of particular example, it is noted that speakers and sound bars often include what are known as keyhole mounts at a rear surface thereof, the keyhole mounts being intended to interact with nails or screws affixed to the wall to support the weight of the speaker/television. The keyhole mounts include a rest surface that rests on the main shaft of the nail/screw, and also include a feed opening that serves as a guide for placing the rest surface on the support structure.

Particularly, the feed opening is generally sized to receive the head of standard sized nails/screws and helps to guide the shaft of the nail/screw up toward the rest surface.

Referring now to FIGS. 1 and 2, an item to be mounted facing a wall is shown and designated by the numeral 10. To provide some context, this item 10 is shown as a sound bar speaker. The item 10 has a rear surface 12 that is to be mounted facing a wall W. The rear surface 12 includes one or more mounting structures 14, which, in this embodiment are in the form of keyhole mounts. These mounting structures 14 are spaced apart so that the item 10 may be securely mounted to the wall W at more than one point. However, it will be appreciated that some items may include only one mounting structure or more than two mounting structures.

The particular keyhole mounts shown at mounting structures 14 include a rest surface 16 and a feed opening 18. The feed opening 18 serves as a guide for the placing of the rest surface 16 on a support structure affixed to the wall W. More particularly, as generally known, one or more support structure 20, typically nails or screws, would be affixed to the wall W at the appropriate location where it is desired to mount the item 10, and the openings 18 of the mounting structures 14 would be placed over the support structures 20 so that an exposed portion of the support structure can move within the slot 19 extending from the feed opening 18 to the rest surface 16 so that the rest surfaces 16 rest on the support structures 20 to support the item 10.

Though a keyhole mount is specifically shown in the specific example, it will be appreciated that other mounting structures include a rest surface and a feed opening. For example, referring to FIG. 3, the prior art provides sawtooth hangers 114 that include a plurality of rest surfaces 116, each with a plurality of feed openings 118 that serve as a guide for placing a desired rest surface 116 on a support structure. These sawtooth hangers are common on picture frames and the like, and the sawtooth structure serves to rest on a support structure such as a nail/screw in most uses. Referring to FIG. 4, it can be seen that a D-ring provides another type of mounting structure 214, including a support surface 216 and feed opening 218. Similarly, FIG. 4 provides a triangle mount 314 that includes a rest surface 316 and feed opening 318.

It will be readily appreciated that it is difficult to mount items to a support structure at a rear surface of the item to be mounted. First, it is difficult to line up the mounting structure and the support structure inasmuch as the body of the item to be mounted typically covers the support structure, when mounted. One is typically left trying to blindly align the mounting structure and the support structure. This is even more difficult when multiple mounting structures are to engage multiple support structures, as, for example, in the construct provided in FIG. 1, where two mounting structures 14 are shown. It will also be appreciated that properly mounting an item to a wall in this manner will require very accurate placement of the support structures on the wall. This is again particularly true when multiple mounting structures are included at the rear surface of the item to be mounted to the wall. The support structures must be appropriately spaced and aligned. This is shown in FIG. 2 by showing the distance “x” spacing the mounting structures 14 must also be the distance spacing the support structures 20 in the wall W. If not accurately spaced, one mounting structure might fit over one support structure, while the other mounting structure does not appropriately align with the other support structure. Additionally, even if spaced appropriately so that all mounting structures align with their respective support structures, there is a chance that the support structures may not be positioned at the appropriate height on the wall W such that the item will not be mounted to the wall in a level manner. This will be particularly important for example in mounting items such as pictures, speakers and televisions.

Presently, when one wishes to mount such items to a wall, one must accurately measure from the ground surface to a desired height for placement of a support structure, and, when there is more than one mounting structure, one must further measure and accurately place the additional support structures such that the support structures as measured and positioned on the wall align with all of the mounting structures on the rear surface of the item to be mounted. If the measurements are not accurately made, the support structures may not align with the mounting structures or the item, when mounted on the support structures, may not be level or stable.

It should also be appreciated that, even if the support structures are accurately measured and positioned on the wall, the item may still mount off level if the mounting structures at the rear surface of the item are not appropriately aligned. It is possible that the manufacturer of the item to be mounted to the wall could provide mounting structures that are not appropriately aligned to mount the item in a level manner, and, as a result, the item would mount off level even if the affixing of the support structures in the wall was accurately measured.

In light of this, there is a need in the art for improvements in items to be mounted to a wall and improvements in methods for mounting them to a wall.

### SUMMARY OF THE INVENTION

A first embodiment of this invention provides a method for mounting an item to a wall, the item having a rear surface to be mounted facing a wall, the rear surface having a mounting structure including: (a) a rest surface that, in use, rests on a support structure affixed to the wall, and (b) a feed opening that serves as a guide for the placing of the rest surface on the support structure, the method comprising the steps of: providing a mounting dowel having a body extending from a mounting end to a marking end, the body being formed of a conformable material proximate said mounting end; providing a marking substance at said marking end of said body; securing the mounting dowel to the item by securing the mounting dowel at the mounting structure by engaging the conformable material proximate the mounting end with the mounting structure, as guided by the feed opening, thereby compromising said conformable material by the contours of the mounting structure proximate the rest surface such that the conformable material is conformed to the contours proximate the rest surface and is held thereby; and after said step of securing the mounting dowel to the item, pressing the marking substance against the wall to which the item is to be mounted to thereby leave a mark at a location for affixing a support structure.

A second embodiment of this invention provide a method as in the first embodiment, wherein the item includes a second mounting structure including: (a) a rest surface that, in use, rests on a support structure affixed to the wall, and (b) a feed opening that serves as a guide for the placing of the rest surface on the support structure, the method further comprising the steps of: providing a second mounting dowel having a body extending from a mounting end to a marking end, the body being formed of a conformable material proximate said mounting end; providing a marking substance at said marking end of said second mounting dowel; and securing the second mounting dowel to the item by securing the mounting dowel at the second mounting structure by engaging the conformable material proximate the mounting end with the second mounting structure, as guided by the feed opening, thereby compromising said conformable material by the contours of the second mounting structure proximate the rest surface such that the conformable material is conformed to the contours proximate the rest surface and is held thereby, wherein said step of pressing includes pressing the marking substance of said second marking dowel against the wall to thereby leave a mark at a second location for affixing a second support structure.

A third embodiment provides a method as in the first or second embodiment, wherein the mounting structure is selected from the group consisting of keyhole mounts, sawtooth hangers, D-ring mounts and triangle mounts.

A fourth embodiment provides a method as in any of the first through third embodiments, wherein the mounting structure is a keyhole mount.

A fifth embodiment provides a method as in any of the first through fourth embodiments, wherein the conformable material is selected from the group consisting of elastomers, rubbers, silicones, foams, sponges and waxes.

A sixth embodiment provides a method as in any of the first through fifth embodiments, wherein the marking substance is selected from the group consisting of ink, paint, graphite, chalk, oil, grease, wax, combustion residue and moisture activated substances.

A seventh embodiment provides a method as in any of the first through sixth embodiments, wherein the marking substance is a moisture activated substance.

An eighth embodiment provides a method as in any of the first through seventh embodiments, wherein the marking substance comprises a dry ink or dry pigment that is moisture activated to be applied to a surface.

A ninth embodiment provides a method as in any of the first through eighth embodiments, wherein the marking substance is a combustion residue.

A tenth embodiment provides a method as in any of the first through ninth embodiments, wherein the mounting dowel is formed of the marking substance.

An eleventh embodiment provides an item having a rear surface to be mounted facing a wall, the rear surface having a mounting structure including: (a) a rest surface that, in use, rests on a support structure affixed to the wall, and (b) a feed opening that serves as a guide for the placing of the rest surface on the support structure, the improvement comprising: a mounting dowel having a body extending from a mounting end to a marking end, said body being formed of a conformable material proximate said mounting end, wherein said mounting dowel is secured at the mounting structure by means of said conformable material being compromised by the contours of the mounting structure proximate the rest surface such that said conformable material is conformed to the contours proximate the rest surface and held thereby; and a marking substance at said marking end of said body.

A twelfth embodiment provides an item as in the eleventh embodiment, wherein the item includes a second mounting structure at the rear surface thereof including: (a) a rest surface that, in use, rests on a support structure affixed to the wall, and (b) a feed opening that serves as a guide for the placing of the rest surface on the support structure, the improvement further comprising: a second mounting dowel having a body extending from a mounting end to a marking end, said body being formed of a conformable material proximate said mounting end, wherein said second mounting dowel is secured at the second mounting structure by means of said conformable material being compromised by the contours of the second mounting structure proximate the rest surface such that said conformable material is conformed to the contours proximate the rest surface and held thereby; and a marking substance at said marking end of said body of said second mounting dowel.

A thirteenth embodiment provides an item as in the eleventh or twelfth embodiments, wherein the mounting structure is selected from the group consisting of keyhole mounts, sawtooth hangers, D-ring mounts and triangle mounts.

A fourteenth embodiment provides an item as in any of the eleventh through thirteenth embodiments, wherein the mounting structure is a keyhole mount.

A fifteenth embodiment provides an item as in any of the eleventh through fourteenth embodiments, wherein the conformable material is selected from the group consisting of elastomers, rubbers, silicones, foams, sponges and waxes.

A sixteenth embodiment provides an item as in any of the eleventh through fifteenth embodiments, wherein the marking substance is selected from the group consisting of ink, paint, graphite, chalk, oil, grease, wax, combustion residue and moisture activated substances.

A seventeenth embodiment provides an item as in any of the eleventh through sixteenth embodiments, wherein the marking substance is a moisture activated substance.

An eighteenth embodiment provides an item as in any of the eleventh through seventeenth embodiments, wherein the marking substance comprises a dry ink or dry pigment that is moisture activated to be applied to a surface.

A nineteenth embodiment provides an item as in any of the eleventh through eighteenth embodiments, wherein the marking substance is a combustion residue.

A twentieth embodiment provides an item as in any of the eleventh through nineteenth embodiments, wherein the mounting dowel is formed of the marking substance.

### BRIEF DESCRIPTION OF THE DRAWINGS

FIG. 1 is a perspective view of an example prior art item to be mounted to a wall through keyhole mounts;

FIG. 2 is perspective view depicting a general prior art process for mounting an item such as that in FIG. 1 to a wall;

FIG. 3 shows a first example of an alternative prior art mounting structure to a keyhole mount;

FIG. 4 shows a second example of an alternative prior art mounting structure to a keyhole mount;

FIG. 5 shows a third example of an alternative prior art mounting structure to a keyhole mount;

FIG. 6 is a perspective view of a mounting dowel in accordance with this invention;

FIG. 7 is a perspective view of the dowel inserted into a keyhole mount opening of a mounting structure;

FIG. 8 is a front view of FIG. 7;

FIG. 9 is a cross-section taken along the line 9-9 of FIG. 8;

FIG. 10 is a perspective view as in FIG. 7, but shown with the dowel pushed up to contact the rest surface of the mounting structure;

FIG. 11 is a front view of FIG. 10;

FIG. 12 is a cross-section taken along the line 12-12 in FIG. 11;

FIG. 13 is a cross-section taken along the line 13-13 in FIG. 11;

FIG. 14 is a perspective view of another embodiment of a mounting dowel, as in FIG. 6, shown with a removable cover on a marking substance; and

FIG. 15 is a perspective view depicting the present inventive process for mounting an item such as that in FIG. 1 to a wall using mounting dowels in accordance with this invention.

### DETAILED DESCRIPTION OF ILLUSTRATIVE EMBODIMENTS

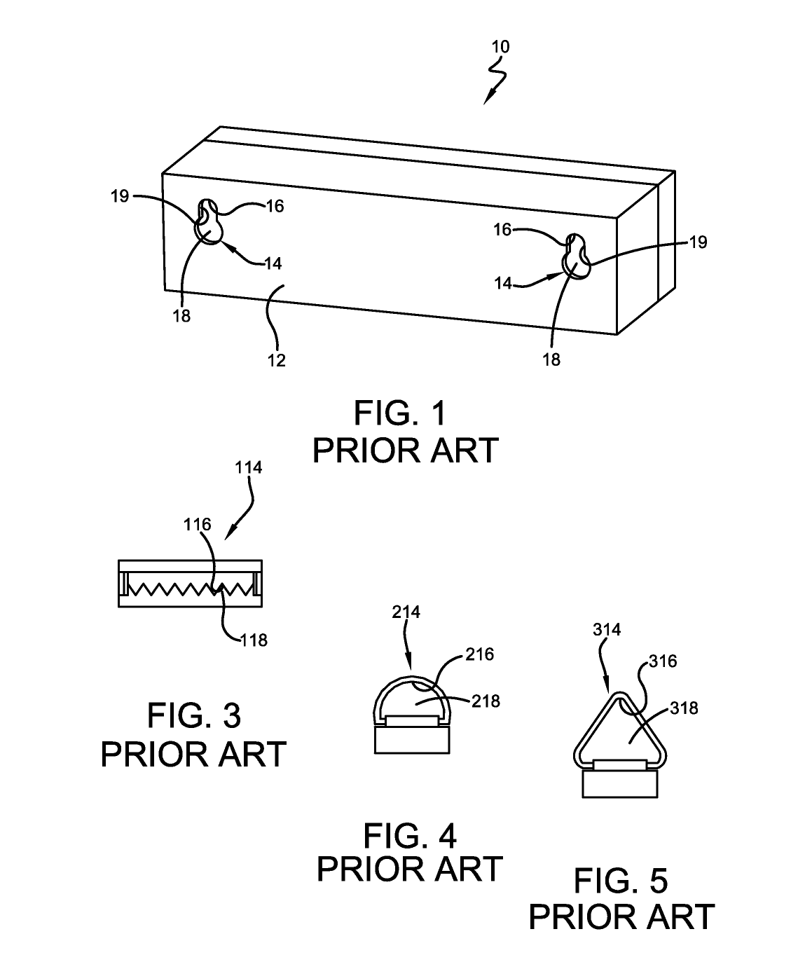

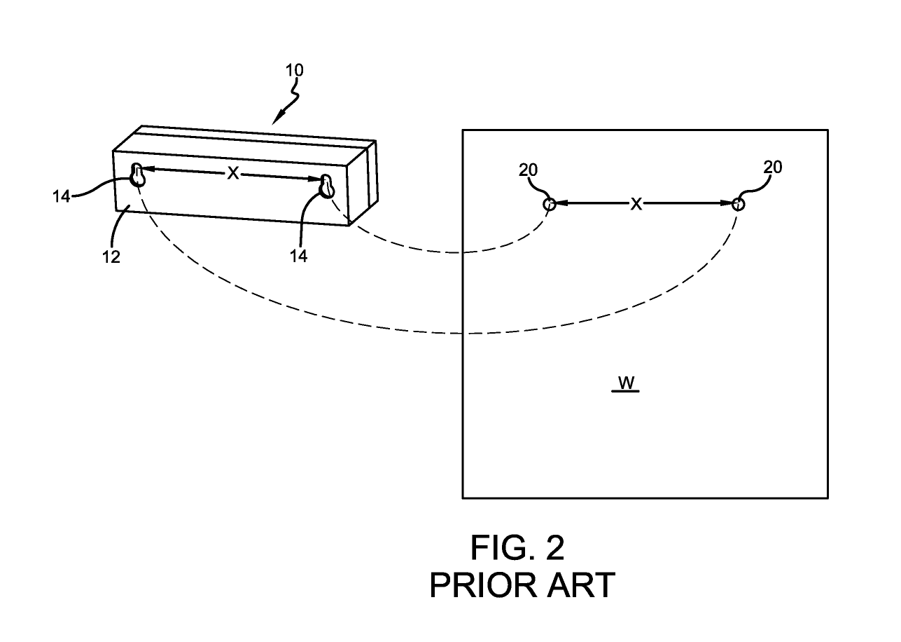

One embodiment of the present invention relates to an improvement in an item to be mounted to a wall. Because it relates to an improvement, the prior art elements will first be disclosed with respect to FIGS. 1 and 2. Thus, the present invention relates to an item 10 having a rear surface 12 to be mounted facing a wall W. The rear surface 12 includes at least one mounting structure 14. The mounting structure 14 includes a rest surface 16 that, in use, rests on a support structure 20 affixed to the wall W. The mounting structure also includes a feed opening 18 that serves as a guide for the placing of the rest surface on the support structure 20. Although the specific mounting structure 14 shown is a keyhole mount, it should be appreciated that other mounting structures including rest surfaces and feed openings can be employed, such as, for example, those mounting structures shown in FIGS. 3-5.

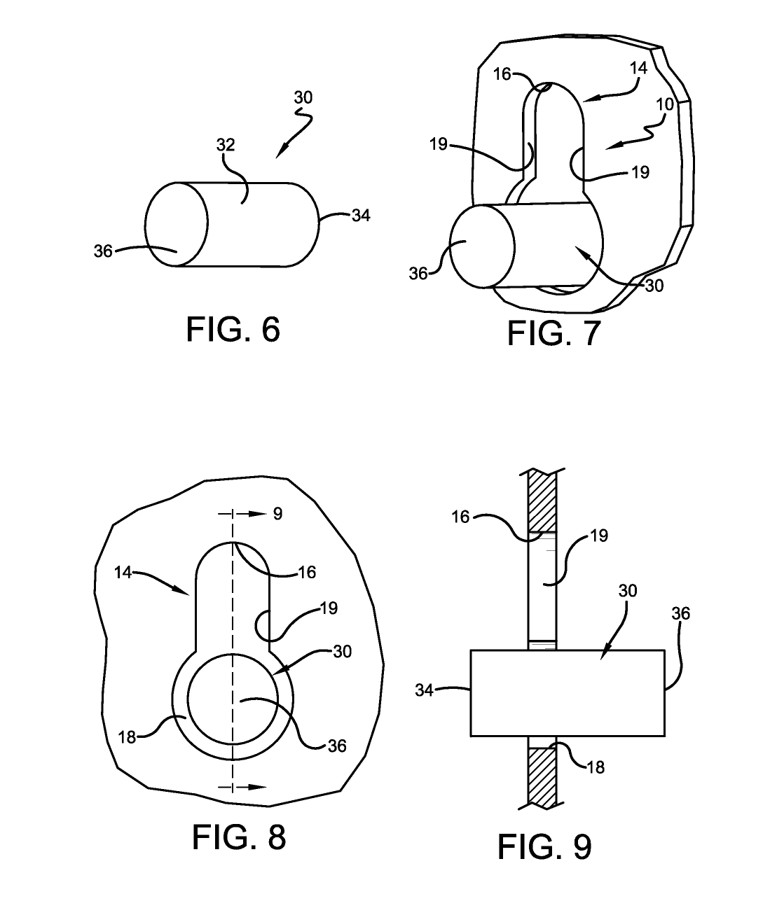

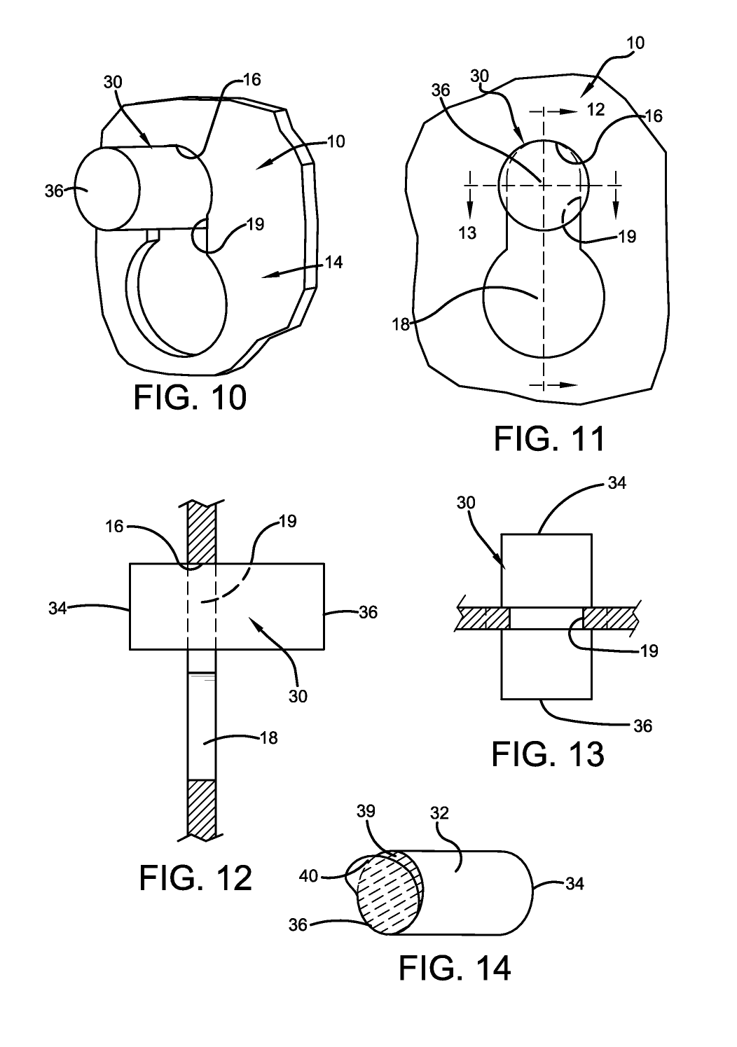

The improvement herein relates to the use of a mounting dowel, as shown in FIGS. 6-13. As seen in FIG. 6, a mounting dowel 30 includes a body 32 extending from a mounting end 34 to a marking end 36. The body 32 is formed from a conformable material proximate the mounting end 34. In some embodiments, the entirety of the body 32 may be formed of the conformable material, but, in order to function as described herein, it is sufficient that only an area proximate the mounting end 36 be made of a conformable material. The proper scope and interpretation of a conformable material will be more apparent as the disclosure of the present invention continues.

Referring now to FIGS. 7-13, the mounting dowel 30 is mounted to a mounting structure 14 of the item 10 by inserting the mounting end 34 in the feed opening 18 of the mounting structure 14 and thereafter moving the mounting end 34 toward the rest surface 16. The body 32 of the mounting dowel 30 is sized larger in width than the distance between the opposed side walls 21 of the slot 19 extending from the feed opening 18 to the rest surface 16, and is also sized smaller in width than the feed opening 18. In light of these dimensions and because the body 32 proximate the mounting end 34 is formed of a conformable material, the mounting dowel 30 is secured at the mounting structure 14 by means of the conformable material being compromised by the contours of the mounting structure 14 proximate the rest surface 16, i.e., by the opposed surfaces 21. The conformable material becomes conformed to the contours proximate the rest surface 16 and is held thereby. Thus, by “compromised” it is meant that the conformable material is compressed or cut into such that being compromised by the contours of the mounting structure means that the conformable material is compressed or cut into by the contours. The conformable material must provided this ability to be compromised. This is intended to result in the holding of the mounting dowel at the contours of the mounting structure at the rest surface.

It will be appreciated that, just as the keyhole mount of the specific embodiment shown includes opposed surfaces 21 at a slot 19 that provide the contours of the mounting structure that compromise the conformable material, other mounting structures such as those shown in FIGS. 3-5 can provide similar contours. For example, the angled surfaces 121 feeding from the feed opening 118 to the rest surface 116 can compromise the conformable material to hold the mounting dowel at the rest surface 116, as can the curved surfaces 121 of FIG. 4 and the angled surfaces 121 of FIG. 5. The present invention is not limited to or by any particular mounting structure.

In some embodiments, the body of the mounting dowel is formed of a conformable material selected from the group consisting of elastomers, rubbers, silicones, foams, sponges and waxes. In some embodiments, an extruded polystyrene foam (e.g., Styrofoam).

In some embodiments, the body proximate the mounting end is formed of a rubber, foam, or other elastomer material that is compromised by being squeezed by the contours of the mounting structure at the rest surface thereof. In some embodiments, the body proximate the mounting end is formed of a foam, sponge, wax, or other conformable material that conforms to the contours at the rest surface of a mounting structure by means of the contours cutting into the material. More particularly, it will be appreciated that an appropriate comformable material can have portions thereof compressed or cut into by the opposed sides of a mounting structure extending from the feed opening to the rest surface.

The marking end 36 of the body 32 is marked with a marking substance 38. The marking substance is virtually any substance that can be imparted to the surface of a wall to leave a mark on the surface. This will be appreciated more fully as the method of using the improvement of the present invention is more fully described.

In some embodiments, the marking substance is selected from the group consisting of ink, pigment, paint, graphite, chalk, oil, grease, wax, combustion residue and moisture activated substances. In some embodiments, the marking substance is a separate substance that is applied to the marking end of the body. For example, inks, pigments, paints, graphites, chalks, oils, greases, and waxes can be applied to the marking end, whether by the manufacturer or end user.

In some embodiments, the marking substance is a substance that is applied to the marking end by the manufacturer and supplied to the end user. With reference to FIG. 14, the marking substance (shown as 39) in some embodiments is protected by a removable cover 40. In some embodiments, the removable cover 40 is a film layer or cap structure. In some embodiments, the marking substance will be a substance that detrimentally dries upon exposure to air, and, in such embodiments, the removable cover 40 can be air tight.

In some embodiments, the marking substance is resilient and does not dry and does not need activation. For example a suitable colored grease or oil might serve as such a marking substance.

In some embodiments, the marking substance is imparted to the marking end of the body by means of applying heat to the marking end so as to partially combust the same and leave behind a combustion residue that can be imparted to the wall. It will be appreciated that certain foams, such as extruded polystyrene foams and the like, will leave behind such a combustion residue when heat or a flame is applied thereto.

In some embodiments, the marking substance is imparted to the marking end by being moisture activated. A moisture-activated substance is either imparted to the marking end or forms the marking end of the body of the mounting dowel. The moisture-activated substance is changed to a marking substance by the application of moisture. In some embodiments, the moisture-activated substance is incapable of marking surfaces until activated by the application of moisture. For example, a dry ink or dry pigment on the marking end can be moistened to wet the ink/pigment and allow it to be applied to a surface.

In some embodiments, the mounting dowel is made of the marking substance. For instance, foams or waxes used for the mounting dowel can be heat activated at the marking end to provide the marking substance. In the case of a wax, heating the end of a wax mounting dowel would provide a marking substance in the form of melted wax. In the case of foam, heating the end of a foam mounting dowel would provide a marking substance in the form of melted or combusted foam. In other embodiments, a foam can be moisture activated to provide a marking substance. By way of example only, a water disintegrable foam might carry a colorant that is released upon the water-activated disintegration of the foam structure. Other substances that can both form the mounting dowel and provide a marking substance may be used in such embodiments.

Employing a mounting dowel in accordance with this invention provides a novel, improved item to be mounted to a wall. Particularly, the present invention provides an improvement in an item having a rear surface to be mounted facing a wall, the rear surface having a mounting structure including: (a) a rest surface that, in use, rests on a support structure affixed to the wall, and (b) a feed opening that serves as a guide for the placing of the rest surface on the support structure, the improvement comprising: a mounting dowel having a body extending from a mounting end to a marking end, said body being formed of a conformable material proximate said mounting end, wherein said mounting dowel is secured at the mounting structure by means of said conformable material being compromised by the contours of the mounting structure proximate the rest surface such that the conformable material is conformed to the contours proximate the rest surface and held thereby; and a marking substance at said marking end of said body.

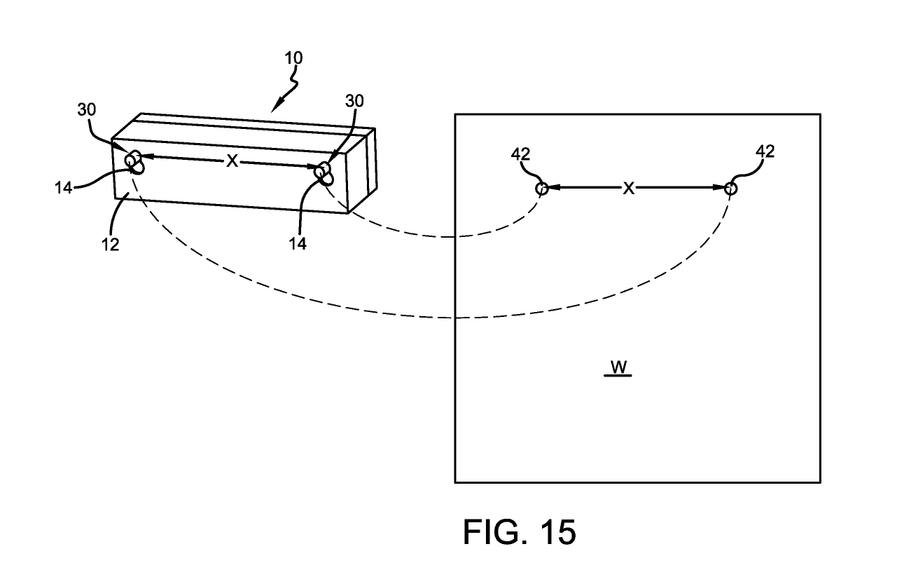

A method of the present invention includes securing a mounting dowel of this invention to a mounting structure at a rear surface of an item, wherein the rear surface is to be mounted facing a wall. The mounting dowel is secured as generally described above, by engaging the conformable material proximate the mounting end with the mounting structure, as guided by the feed opening, thereby compromising the conformable material by the contours of the mounting structure proximate the rest surface such that the conformable material is conformed to the contours proximate the rest surface and is held thereby. This is generally shown in FIG. 15. Either before or after securing the mounting dowel in this fashion, the marking end of the mounting dowel is provided with a marking substance, either by application of a marking substance to the marking end or by compromising the marking end, as, for example, by the combustion method previously disclosed.

After the mounting dowel is secured to the mounting structure and its marking end is provided with a marking substance, the marking substance is pressed against the wall to which the item is to be mounted to thereby leave one or more marks 42 (depending on the number of mounting dowels employed) at a location for affixing a support structure. This is generally represented in FIG. 15.

Notably, when an item to be mounted to a wall includes more than one mounting structure at a rear surface thereof, the present invention serves to ensure that the wall can be accurately marked for affixing each mounting structure to a support structure. Instead of measuring and marking the wall for location of support structures, the location of the mounting structures at the rear surface of the item to be mounted serve as a template for using the mounting dowels to mark the wall. One could still measure for a desired height, but would only have to measure one mounting structure, as the other mounting structures would automatically be appropriately located through the method of the present invention. Additionally, by placing a level on the item to be mounted, it would be possible to ensure a level mounting of the item, again, without having to measure from a ground or ceiling to determine appropriate locations for the support structures. Notably, even if the mounting structures are manufactured improperly and are not level, the method of the present invention automatically compensates for such manufacturing defects, and a level mounting can be ensured merely by placing a level on the item to be mounted and ensuring it registers a level orientation thereof before pressing the marking end of the mounting dowels against the wall.

In a specific embodiment, the mounting dowel is made of foam, and the marking substance is a moisture activated marking substance. In this embodiment, securing the mounting dowel to the mounting structure includes inserting the mounting end in the feed opening and moving the mounting dowel to the rest surface thereof. As the mounting dowel is moved toward the rest surface, foam material is cut into or compressed by the opposed sidewalls and the mounting dowel is held at the rest surface. The marking substance is then activated at the marking end of the mounting dowel by the application of moisture, and the proper location for a support structure on a wall can be established by pressing the marking substance against the wall. The marking substance in some such embodiments is a dry ink or dry pigment that is activated by moisture to become wet and capable of leaving a mark upon pressing against a surface. A level can be used to ensure a subsequent level mounting of the item. In some such particular embodiments, the mounting structure of the item to be mounted to a wall is a keyhole mount. The mounting dowel is dimensioned larger in width than the distance between the opposed side walls of the slot extending from the feed opening to the rest surface, and is also dimensioned smaller in width than the feed opening. Thus, the foam material of the mounting dowel is cut into or compressed by the opposed sidewalls and the mounting dowel is held at the rest surface. In some such embodiments, the foam material is cut into. In others, it is compressed.

In another specific embodiment, the mounting dowel is made of foam, and the marking substance is a chalk. In this embodiment, securing the mounting dowel to the mounting structure includes inserting the mounting end in the feed opening and moving the mounting dowel to the rest surface thereof. As the mounting dowel is moved toward the rest surface, foam material is cut into or compressed by the opposed sidewalls and the mounting dowel is held at the rest surface. The chalk marking substance is then applied (or could be applied before mounting) at the marking end of the mounting dowel, and the proper location for a support structure on a wall can be established by pressing the marking substance against the wall. A level can be used to ensure a subsequent level mounting of the item. In some such particular embodiments, the mounting structure of the item to be mounted to a wall is a keyhole mount. The mounting dowel is dimensioned larger in width than the distance between the opposed side walls of the slot extending from the feed opening to the rest surface, and is also dimensioned smaller in width than the feed opening. Thus, the foam material of the mounting dowel is cut into or compressed by the opposed sidewalls and the mounting dowel is held at the rest surface. In some such embodiments, the foam material is cut into. In others, it is compressed.

In a specific embodiment, the mounting dowel is made of a wax, and the marking substance is provided by heating the marking end of ht mounting dowel, thus providing a melted wax residue that can be imparted to a surface by touching the marking end thereto. In this embodiment, securing the mounting dowel to the mounting structure includes inserting the mounting end in the feed opening and moving the mounting dowel to the rest surface thereof. As the mounting dowel is moved toward the rest surface, the was material forming the mounting dowel is cut into by the opposed sidewalls and the mounting dowel is held at the rest surface. The marking substance is then imparted to the marking end by applying heat and thus melting a portion of the wax. The proper location for a support structure on a wall can be established by pressing the marking substance against the wall. A level can be used to ensure a subsequent level mounting of the item. In some such particular embodiments, the mounting structure of the item to be mounted to a wall is a keyhole mount. The mounting dowel is dimensioned larger in width than the distance between the opposed side walls of the slot extending from the feed opening to the rest surface, and is also dimensioned smaller in width than the feed opening. Thus, the wax material of the mounting dowel is cut into by the opposed sidewalls and the mounting dowel is held at the rest surface.

In light of the foregoing, it should be appreciated that the present invention significantly advances the art by providing an improvement in items to be mounted to a wall and improvements to their method of mounting that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method for mounting an item to a wall, the item having a rear surface to be mounted facing a wall, the rear surface having a mounting structure including:
(a) a rest surface that, in use, rests on a support structure affixed to the wall, and
(b) a feed opening that serves as a guide for the placing of the rest surface on the support structure, the method comprising the steps of:
providing a mounting dowel having a body extending from a mounting end to a marking end, the body being formed of a conformable material proximate said mounting end;
providing a marking substance at said marking end of said body;
securing the mounting dowel to the item by securing the mounting dowel at the mounting structure by engaging the conformable material proximate the mounting end with the mounting structure, as guided by the feed opening, thereby compromising said conformable material by the contours of the mounting structure proximate the rest surface such that the conformable material is conformed to the contours proximate the rest surface and is held thereby; and
after said step of securing the mounting dowel to the item, pressing the marking substance against the wall to which the item is to be mounted to thereby leave a mark at a location for affixing a support structure.

2. The method of claim 1, wherein the item includes a second mounting structure including: (a) a rest surface that, in use, rests on a support structure affixed to the wall, and (b) a feed opening that serves as a guide for the placing of the rest surface on the support structure, the method further comprising the steps of:
providing a second mounting dowel having a body extending from a mounting end to a marking end, the body being formed of a conformable material proximate said mounting end;
providing a marking substance at said marking end of said second mounting dowel; and
securing the second mounting dowel to the item by securing the mounting dowel at the second mounting structure by engaging the conformable material proximate the mounting end with the second mounting structure, as guided by the feed opening, thereby compromising said conformable material by the contours of the second mounting structure proximate the rest surface such that the conformable material is conformed to the contours proximate the rest surface and is held thereby, wherein said step of pressing includes pressing the marking substance of said second marking dowel against the wall to thereby leave a mark at a second location for affixing a second support structure.

3. The method of claim 1, wherein the mounting structure is selected from the group consisting of keyhole mounts, sawtooth hangers, D-ring mounts and triangle mounts.

4. The method of claim 1, wherein the mounting structure is a keyhole mount.

5. The method of claim 1, wherein the conformable material is selected from the group consisting of elastomers, rubbers, silicones, foams, sponges and waxes.

6. The method of claim 1, wherein the marking substance is selected from the group consisting of ink, paint, graphite, chalk, oil, grease, wax, combustion residue and moisture activated substances.

7. The method of claim 1, wherein the marking substance is a moisture activated substance.

8. The method of claim 7, wherein the marking substance comprises a dry ink or dry pigment that is moisture activated to be applied to a surface.

9. The method of claim 8, wherein the marking substance is a combustion residue.

10. The method of claim 1, wherein the mounting dowel is formed of the marking substance.

11. In an item having a rear surface to be mounted facing a wall, the rear surface having a mounting structure including: (a) a rest surface that, in use, rests on a support structure affixed to the wall, and (b) a feed opening that serves as a guide for the placing of the rest surface on the support structure, the improvement comprising:
a mounting dowel having a body extending from a mounting end to a marking end, said body being formed of a conformable material proximate said mounting end, wherein said mounting dowel is secured at the mounting structure by means of said conformable material being compromised by the contours of the mounting structure proximate the rest surface such that said conformable material is conformed to the contours proximate the rest surface and held thereby; and
a marking substance at said marking end of said body.

12. The item of claim 11, wherein the item includes a second mounting structure at the rear surface thereof including: (a) a rest surface that, in use, rests on a support structure affixed to the wall, and (b) a feed opening that serves as a guide for the placing of the rest surface on the support structure, the improvement further comprising:
a second mounting dowel having a body extending from a mounting end to a marking end, said body being formed of a conformable material proximate said mounting end, wherein said second mounting dowel is secured at the second mounting structure by means of said conformable material being compromised by the contours of the second mounting structure proximate the rest surface such that said conformable material is conformed to the contours proximate the rest surface and held thereby; and
a marking substance at said marking end of said body of said second mounting dowel.

13. The item of claim 11, wherein the mounting structure is selected from the group consisting of keyhole mounts, sawtooth hangers, D-ring mounts and triangle mounts.

14. The item of claim 11, wherein the mounting structure is a keyhole mount.

15. The item of claim 11, wherein the conformable material is selected from the group consisting of elastomers, rubbers, silicones, foams, sponges and waxes.

16. The method of claim 11, wherein the marking substance is selected from the group consisting of ink, paint, graphite, chalk, oil, grease, wax, combustion residue and moisture activated substances.

17. The method of claim 1, wherein the marking substance is a moisture activated substance.

18. The method of claim 17, wherein the marking substance comprises a dry ink or dry pigment that is moisture activated to be applied to a surface.

19. The method of claim 11, wherein the marking substance is a combustion residue.

20. The method of claim 11, wherein the mounting dowel is formed of the marking substance.
